(19) United States
(12) Patent Application Publication
(10) Pub. No.: US 2014/0334836 A1
(43) Pub. Date: Nov. 13, 2014

(54) IMAGE FORMING DEVICE

(71) Applicant: Konica Minolta, Inc., Chiyoda-ku (JP)

(72) Inventors: Tsugihito YOSHIYAMA, Toyohashi-shi (JP); Tomohisa Yoshida, Toyokawa-shi (JP); Yoshiki Nakane, Toyokawa-shi (JP); Yohei Ito, Toyokawa-shi (JP); Masanori Kawada, Toyokawa-shi (JP)

(73) Assignee: Konica Minolta, Inc., Chiyoda-ku (JP)

(21) Appl. No.: 14/270,395

(22) Filed: May 6, 2014

(30) Foreign Application Priority Data
May 13, 2013 (JP) 2013-100811

(51) Int. Cl. G03G 15/08; G03G 21/00

(52) U.S. Cl. CPC G03G 15/0822
USPC 399/53; 399/346

(57) ABSTRACT

An image forming device includes an image carrying member that is rotatable, a development unit that develops an image on the image carrying member, a transfer unit that transfers a developed toner image from the image carrying member to a transferred member, a cleaning unit making contact with the surface of the image carrying member, a lubricant application unit that applies a lubricant to the surface of the image carrying member; and a switching control unit that switches a development condition of the development unit between a first mode in which the lubricant applied to the surface of the image carrying member is unlikely to be moved to the development unit and a second mode other than the first mode. The development condition is set at the first mode at a time of no image formation such that the lubricant is applied to the image carrying member.

This application is based on Japanese Patent Application No. 2013-100811 filed on May 13, 2013 the contents of which are hereby incorporated by reference.

### BACKGROUND OF THE INVENTION

1. Field of the Invention

The present invention relates to image forming devices.

2. Description of the Related Art

In recent years, electrophotographic image forming devices have been required to enhance image qualities such as high resolution and the reproducibility of photographs, and as a significant method for satisfying such requirement, the particle diameter of toner is reduced or toner is spherically formed.

However, when the particle diameter of toner is reduced or toner is spherically formed, the toner is easily passed between a cleaning blade and a photosensitive member. This is because when the toner is spherically formed, adhesion caused by the van der Waals' force between the toner and the photosensitive member is increased, and the toner easily enters between the photosensitive member and the cleaning blade (nip portion). This is also because when the toner is spherically formed, the toner is easily rolled over between the photosensitive member and the cleaning blade, and thereby easily enters the nip portion.

When a so-called cleaning failure occurs in which toner is passed between a cleaning blade and a photosensitive member, the toner is transferred to the subsequent image to make black-striped image noise or the passed toner interrupts light in an exposure step, and thus part of a latent mage is not produced.

Hence, in order to reduce the passing of toner between a cleaning blade and a photosensitive member, a technology is proposed in which a lubricant formed with zinc stearate and the like is applied to the surface of the photosensitive member with a brush and thus the friction coefficient of the photosensitive member is lowered (for example, Japanese Unexamined Patent Application Publication Nos. 2009-222770, 2010-230931 and 2008-89771). The application of the lubricant onto the photosensitive member lowers the adhesion and frictional force of the toner to the photosensitive member, and thus it is possible to sufficiently remove the toner with the cleaning blade. The toner is easily removed from the photosensitive member, and thus it is possible to reduce the contact force of the cleaning blade with the photosensitive member, with result that it is possible to increase the life of the cleaning blade and the photosensitive member. Furthermore, the friction coefficient of the photosensitive member is reduced, and thus the efficiency of transfer of a toner image is enhanced, and the adherence of a foreign material such as filming to the photosensitive member is prevented.

However, in order to achieve the above effects, it is necessary to apply the lubricant over the entire surface of the photosensitive member. Even when a region to which the lubricant is not applied is partially present, a difference of the friction coefficient between the application portion and the non-application portion is produced, and thus an unevenness of concentration caused by an unevenness of transfer, a cleaning failure or filming is produced. By a variation in torque caused by a partial unevenness of the friction coefficient, an image failure such as an unevenness of pitch is also produced. When the photosensitive member is continuously used in a state where the friction coefficient is high, the wear of the cleaning blade and the photosensitive member is facilitated, with result that the life of the cleaning blade and the photosensitive member is disadvantageously reduced.

A lubricant layer applied onto the photosensitive member is ground by an external additive contained in the toner in a cleaning portion. Hence, the amount of grinding of the lubricant layer is varied by a print coverage rate of an image. For example, when the image formation of a high print coverage rate is continued, the amount of toner untransferred onto the photosensitive member is increased, and the amount of external additive transported to the cleaning portion together with the untransferred toner is also increased, with result that the amount of grinding of the lubricant layer is increased. Hence, in order to keep the thickness of the lubricant layer on the photosensitive member a predetermined thickness or more, it is necessary to apply the lubricant corresponding to this maximum amount of grinding to the photosensitive member.

The lubricant applied to the photosensitive member is generally levelled with a leveling blade so as to fill the region to which the lubricant is not applied, and thus the lubricant layer is formed over the entire surface of the photosensitive member. Then, when the lubricant is further applied, as a predetermined amount is exceeded, the lubricant layer starts to partially grow so as to form in a convex shape. Furthermore, when the lubricant is applied, the thickness of the lubricant layer is increased so as to fill the concave portion of the lubricant layer, and the partial convex shape further grows. When as described above, the amount of lubricant applied is increased, the thickness of the lubricant layer is increased, and simultaneously, the projection and recess of the lubricant layer are increased in size.

When the lubricant layer formed on the photosensitive member is passed through a development portion, the lubricant layer is scrubbed by a magnetic brush and part of the lubricant layer is scraped and is taken in by a developer. In particular, since the part of the lubricant layer grown in the convex shape is easily separated, as the size of the projection and recess of the lubricant layer is increased, the mixing of the lubricant with the developer is increased. When the lubricant is mixed with the developer, the amount of charge of the toner in the developer is reduced, and thus the amount of powder smoke is increased. Then, the powder smoke produced in a development device stains a charging device and an exposure device to produce an unevenness of an image, and insufficient transfer occurs in a transfer portion to cause the lowering of image quality such as a reduction in image concentration and foging.

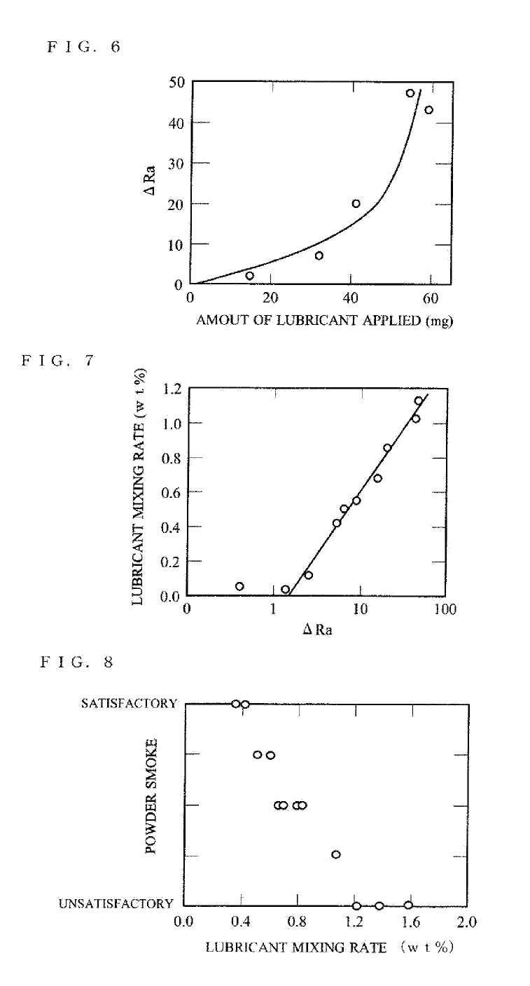

FIG. 6 shows a relationship, when zinc stearate is used as a solid lubricant, between a difference ΔRa in the surface roughness of the photosensitive member before and after the application of the lubricant and the amount of lubricant applied. As is clear from the figure, as the amount of lubricant applied is increased, the difference ΔRa in the surface roughness of the photosensitive member is increased. The surface roughness Ra of the photosensitive member is calculated from data on only a center portion (0.55 mm×0.40 mm) after a low-frequency component of 30 mm or less is removed with a Gaussian filter from surface roughness profile data measured with “Wyko NT9100”, a light interference type surface profile roughness measurement system, made by Neeco Ltd., and mask processing is performed on a peripheral portion. In this way, the roughness component in the surface of the photosensitive member is removed, and a displacement from the center portion of the recess and projection in an edge portion of a Fourier filter-processed image caused by an edge effect is also removed. Then, ΔRa is the difference in the surface roughness Ra calculated as described above before and after the application of the lubricant. In order to enhance the sensitivity, ΔRa is calculated from the difference of Ra measured after the sufficient application of the lubricant in a state where the developer is not in contact with the surface of the photosensitive member.

FIG. 7 shows a relationship between ΔRa and a rate of mixing of the lubricant with the developer. It is found from this figure that as ΔRa is increased, the amount of lubricant mixed with the developer is increased. This is probably because as described above, the part of the lubricant layer in the convex shape is easily separated by an external force from the lubricant layer, and when the lubricant layer is passed through the development portion, the lubricant layer is scrubbed with the magnetic brush, and the part of the lubricant layer in the convex shape is scraped and is taken in by the developer. As shown in FIG. 8, when the lubricant is mixed with the developer, the powder smoke is increased. This occurs probably because the lubricant mixed with the developer prevents friction charge between the toner and a carrier, and thus the amount of charge on the toner is reduced.

### SUMMARY OF THE INVENTION

An object of the present invention is to reduce the movement of a lubricant to a development device while keeping substantially constant the thickness of a lubricant layer on a photosensitive member, to prolong the life of the photosensitive member and a cleaning blade and to reduce the production of powder smoke in the development device.

To achieve the above object, according to the present invention, there is provided an image forming device including: an image carrying member that is rotatable; a charging unit that uniformly charges the surface of the image carrying member; an exposure unit that exposes the image carrying member whose surface is uniformly charged to form an electrostatic latent image; a development unit that is opposite the image carrying member, that includes a developer carrying member which carries a developer containing a toner and which rotates and transports the developer to a position opposite the image carrying member and that develops, with the developer, the electrostatic latent image formed on the surface of the image carrying member; a transfer unit that transfers a developed toner image from the image carrying member to a transferred member; a lubricant application unit that is provided on a downstream side in a direction of rotation of the image carrying member with respect to the transfer unit and applies a lubricant to the surface of the image carrying member; a cleaning unit that is provided on a downstream side in the direction of rotation of the image carrying member with respect to the lubricant application unit and that makes contact with the surface of the image carrying member to clean the surface of the image carrying member, where the image forming device further comprises a switching control unit that switches a development condition of the development unit between a first mode in which the lubricant applied to the surface of the image carrying member is unlikely to be moved to the development unit and a second mode other than the first mode, and the development condition is set at the first mode at the time of no image formation such that the lubricant is applied to the surface of the image carrying member by the lubricant application unit.

In the first mode, the amount of the developer transported the developer carrying member to the position opposite the image carrying member may be reduced than in the second mode.

Alternatively, in the first mode, a distance between the developer carrying member and the image carrying member may be greater than in the second mode.

Furthermore, in the second mode, a voltage obtained by superimposing an alternating-current development bias voltage on a direct-current development bias voltage may be applied between the developer carrying member and the image carrying member, and in the first mode, only the direct-current development bias voltage may be applied therebetween.

Alternatively, before the image formation, after the image formation, between the image formation and the image formation in rounds of the image formation and during interruption of the image formation, the development condition may be set at the first mode such that the lubricant is applied to the surface of the image carrying member by the lubricant application unit.

Alternatively, at the time of no image formation after a print coverage rate of an image and a number of sheets of images formed are detected and a result of the detection satisfies a predetermined condition, the development condition may be set at the first mode such that the lubricant is applied to the surface of the image carrying member by the lubricant application unit.

Preferably, the charging unit does not make contact with the image carrying member.

Preferably, the lubricant application unit is provided on a downstream side in a direction of rotation of the image carrying member with respect to the cleaning member.

Preferably, the lubricant application unit includes a solid lubricant, an application brush that scrubs the lubricant with a brush and applies the lubricant to the image carrying member and a leveling blade that levels the lubricant applied by the application brush in a direction of a shaft of the image carrying member.

Preferably, before the development condition is switched from the first mode to the second mode, during at least one revolution of the image carrying member, a potential difference between the application brush and the image carrying member is set at a potential difference where the lubricant is moved to the application brush more than in the first mode.

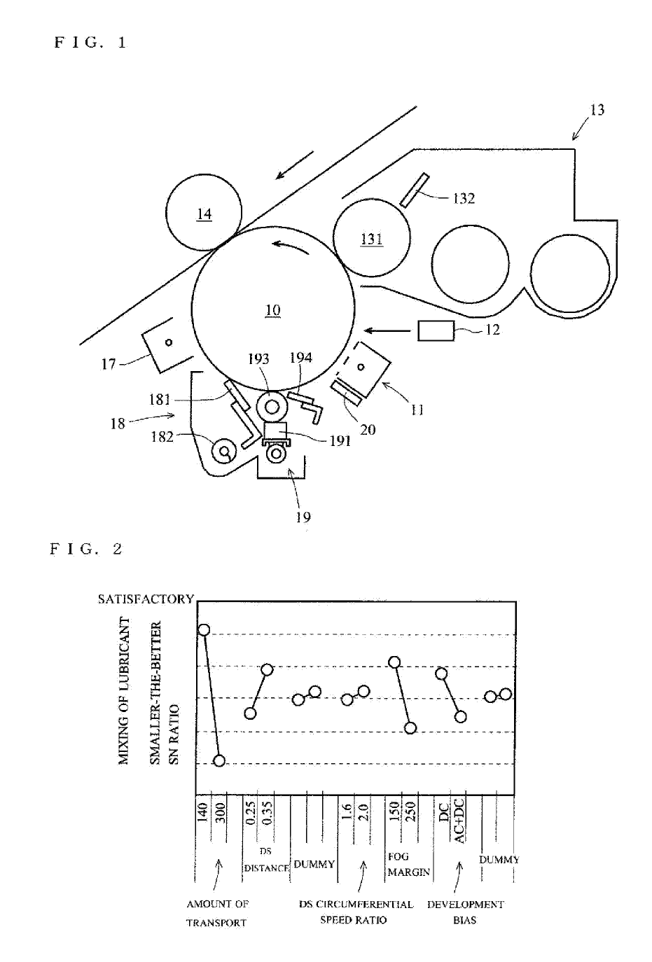

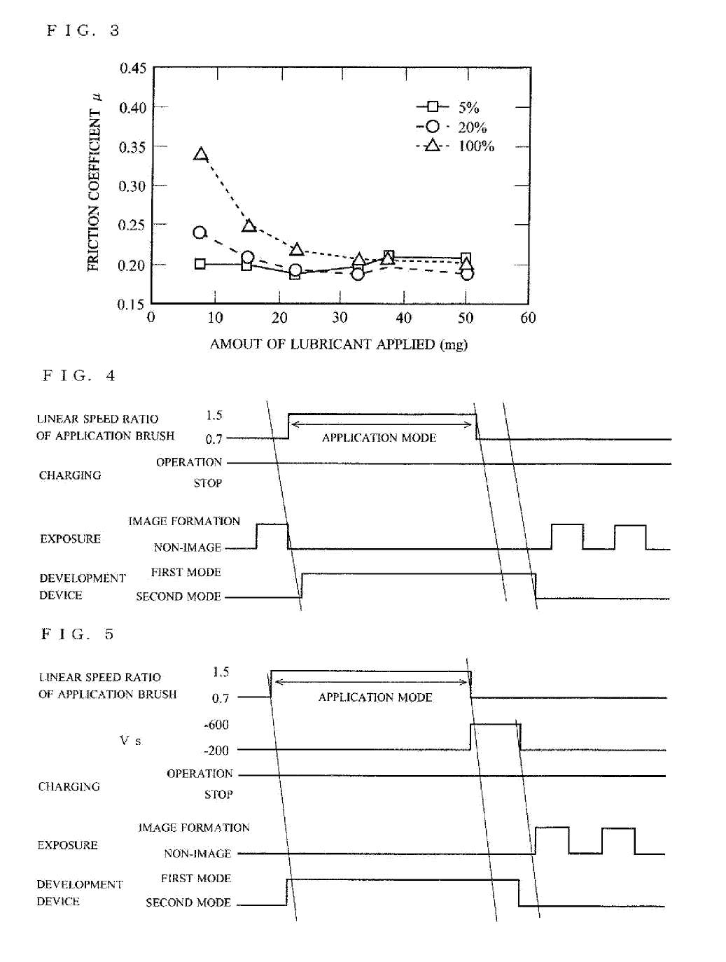

### BRIEF DESCRIPTION OF THE DRAWINGS

[FIG. 1] A schematic diagram showing an example of the main configuration of an image forming device according to the present invention;

[FIG. 2] A factor-effect diagram showing the result of an L8 orthogonal experiment;

[FIG. 3] A diagram showing a relationship between the friction coefficient μ of the surface of a photosensitive drum and the amount of lubricant applied;

[FIG. 4] An example of a timing chart for switching the amount of lubricant applied and development conditions;

[FIG. 5] An example of a timing chart when a portion of a lubricant layer in a convex shape is scrubbed by an application brush 193;

[FIG. 6] A diagram showing a relationship between a difference ΔRa in the surface roughness of the photosensitive member before and after the application of the lubricant and the amount of lubricant applied;

[FIG. 7] A diagram showing a relationship between a rate of mixing of the lubricant with the developer and the difference ΔRa in the surface roughness of the photosensitive member before and after the application of the lubricant; and

[FIG. 8] A diagram showing a relationship between powder smoke produced in a development device and the rate of mixing of the lubricant with the developer.

### DESCRIPTION OF PREFERRED EMBODIMENTS

An image forming device according to the present invention will be described below with reference to accompanying drawings; the present invention is not limited to these embodiments.

FIG. 1 is a schematic diagram showing an example of the main configuration of an image forming device according to the present invention. The image forming device shown in this figure includes, around a photosensitive drum (image carrying member) 10, a charging device (charging unit) 11, an exposure device (exposure unit) 12, a development device (development unit) 13, a transfer roller (transfer unit) 14, a static eliminator 17, a cleaning device (cleaning unit) 18, a lubricant application device (lubricant application unit) 19 and a light static eliminator 20.

The photosensitive drum 10 is made by forming a photosensitive layer of resin containing an organic photoconductor on the outer circumferential surface of a drum-shaped metal base member, and the photosensitive layer includes a charge generation layer and a charge transport layer. On the outermost layer of the photosensitive drum 10, an overcoat layer whose thickness is about 5 μm is formed. In the overcoat layer, SiO₂ particles whose diameter is about 50 nm are distributed substantially uniformly. Thus, recesses and projections are formed in the surface of the photosensitive drum 10, and the retention of a solid lubricant 191 such as zinc stearate, which will be described later, is enhanced, with result that the excessive consumption of the solid lubricant 191 is reduced.

The charging device 11 is a Scorotron charger that includes a grid electrode and a discharge electrode, and charges the photosensitive drum 10 uniformly. For example, when a charging bias of Vc=−6 kV is applied to the discharge electrode, and a bias of Vg=−600 V is applied to the grid electrode, the photosensitive drum 10 is uniformly charged at about Vo=−600 V.

The exposure device 12 exposes the photosensitive drum 10 with laser light to form an electrostatic latent image on the photosensitive drum 10. The laser light is read by a scanner (not shown), and is applied to the photosensitive drum 10 based on an image signal obtained by conversion into an electrical signal with a CD sensor (not shown). At the part to which the laser light is applied, the voltage is attenuated to about Vi=−80 V.

The development device 13 incorporates a two-component developer containing toner and a carrier having magnetism. The toner is negatively charged by friction charge with the carrier. The development device 13 incorporates a magnet to retain the two-component developer of toner and the carrier, and includes a development sleeve (developer carrying member) 131 that is rotated and transported to a position opposite the photosensitive drum 10 (development region), and a restriction blade 132 that restricts the amount of developer transported on the development sleeve 131 to a predetermined amount. A development bias voltage obtained by superimposing an alternating-current development bias voltage Vpp=1 kV having a frequency of 3 kHz on a direct-current development bias voltage Vdc=−450 V is applied to the development sleeve 131, and the negatively charged toner is moved to an image portion on the photosensitive drum 10 by a potential difference between Vdc and Vi and the electrostatic latent image is developed by the toner.

Thereafter, a toner image on the photosensitive drum 10 is transferred by the transfer roller 14 to a transfer member such as an intermediate transfer member or paper. For example, when the image forming device is a tandem-type full-color image forming device, a primary transfer unit is formed with a primary transfer roller that is arranged so as to form a primary transfer region in a state where the primary transfer roller is pressed onto the surface of the photosensitive drum 10 through an intermediate transfer belt and a transfer current application device that is formed, for example, a constant current power supply connected to this primary transfer roller. By a positively charged transfer bias applied with the transfer voltage application device to the primary transfer roller, the toner image on the photosensitive drum 10 is transferred to the intermediate transfer belt.

The static eliminator 17 is a Corotron charger that applies a bias voltage obtained by superimposing an alternating-current voltage (4 kV, a frequency of 1 kHz) to a direct-current voltage (0 to −3 kV). The photosensitive drum 10 positively charged by the transfer roller 14 is negatively and uniformly charged by the static eliminator 17, and thus the storage of the toner image is eliminated.

The cleaning device 18 includes: a cleaning blade 181 that removes the untransferred toner on the photosensitive drum 10 from the photosensitive drum 10 and that is made of urethane robber; and a collection screw 182 that collects the untransferred toner scraped by the cleaning blade 181. The untransferred toner scraped by the cleaning blade 181 is transported and collected by the collection screw 182 into a waste toner box (not shown).

The lubricant application device 19 includes the solid lubricant 191 and an application brush 193 for applying the solid lubricant 191 to the photosensitive drum 10; the solid lubricant 191 receives a force acting in the direction of the application brush 193 by an unillustrated force application unit.

The solid lubricant 191 is obtained by melting and forming the power of zinc stearate, and is formed substantially in the shape of a rectangular parallelepiped extending in the direction of the shaft of the photosensitive drum 10. As the solid lubricant 191, not only zinc stearate but also a fatty acid metal salt such as magnesium stearate or lithium stearate is preferably used. The solid lubricant 191 is adhered and retained with a double-sided tape or the like to a retaining member formed with a plate metal, a resin or the like.

The application brush 193 includes a metallic rotation shaft, a base cloth retained on the rotation shaft and a loop-shaped brush member woven in the base cloth. As the rotation shaft, for example, there is an iron rotation shaft having a diameter of 6 mm. As the brush member, there is a straight hair brush made of a fiber which is formed of conductive acrylic and whose thickness is 3 T (decitex) and density is 225 kF/inch². As a method of weaving the brush member, the brush member is woven in the shape of a loop or a straight hair. The resistance value of the brush member preferably falls within a range of 10⁴ to 10¹⁰Ω, and more preferably falls within a range of 10⁶ to 10⁸Ω. When the outside diameter of the application brush 193 is 12 mm, since the fiber is woven on the base cloth having a thickness of about 0.5 mm, the length of the fiber of the brush member is about 2.5 mm.

The application brush 193 is rotated in contact with the photosensitive drum 10. The application brush 193 may be rotated together with the rotation of the photosensitive drum 10 or may be driven to rotate independently.

The solid lubricant 191 is pressed onto the application brush 193 driven to rotate and thus the solid lubricant 191 is cut away by the application brush 193 and is applied to the photosensitive drum 10. When the applied solid lubricant 191 is passed through a leveling blade 194 made of urethane rubber, it is levelled by the pressing force of the leveling blade 194, and a lubricant layer is formed on the surface of the photosensitive drum 10. Since the lubricant layer formed of zinc stearate has a high releasability and a low friction coefficient, the transferability and the cleaning capability are enhanced. Moreover, since the pressing force of the cleaning blade 181 onto the photosensitive drum 10 can be reduced, it is possible to reduce the wear of the photosensitive drum 10 and the cleaning blade 181.

The lubricant application device 19 may be arranged on the downstream side in the direction of rotation of the photosensitive drum 10 with respect to the cleaning device 18 (downstream application) or may be arranged between the transfer roller 14 and the cleaning device 18 on the upstream side in the direction of rotation of the photosensitive drum 10 with respect to the cleaning device 18 (upstream application). Although in the upstream application, one blade can be used both as the cleaning blade 181 and as the leveling blade 194, since the application brush 193 is stained by the untransferred toner, and thus the application of the lubricant by the application brush 193 may be degraded, the downstream application is recommended.

The light static eliminator 20 is an LED (light emitting diode) array, and light is applied to the photosensitive drum 10, and thus a potential left on the photosensitive drum 10 is uniformly reduced to about −20 V, with result that in the subsequent image formation, the history (memory image) of an image formed in the previous image formation is prevented from being left.

As a result of various examinations, the present inventor, et al. have found that it is possible to reduce the movement of the lubricant to the development device 13 depending on development conditions. Hence, the conditions of application of the lubricant were kept constant, and an L8 orthogonal experiment was conducted while the development conditions (the amount of developer transported, the photosensitive drum-development sleeve distance (DS distance), the photosensitive drum-development sleeve circumferential speed ratio, the fog margin voltage and the development bias) were being changed). Here, the fog margin voltage ΔV1 is a difference between the surface potential (V) of the photosensitive drum and the development bias voltage (Vdc). FIG. 2 shows a factor effect diagram. In FIG. 2, the vertical axis is a smaller-the-better SN ratio, and as the SN ratio is increased, the amount of developer mixed with the lubricant is decreased.

As is clear from FIG. 2, in a case where the contact of the developer on the development sleeve with the photosensitive drum is reduced, such as a case where the amount of developer transported is low, a case where the DS distance is long or a case where the development bias is formed with only a DC current, the amount of developer mixed with the lubricant is reduced. As the fog margin voltage ΔV1 is decreased, the amount of developer mixed with the lubricant is reduced. This is because since the lubricant on the photosensitive drum is negatively charged, when the photosensitive drum is negatively charged, as the fog margin voltage ΔV1 is increased, the lubricant is more likely to be moved to the development sleeve.

The above results show that, preferably, before image formation, after image formation, between image formation and image formation in rounds of image formation and in an interruption of image formation, the development conditions are set at a first mode, and the lubricant is applied with the lubricant application device 19 to the photosensitive drum 10. In this way, the movement of the lubricant to the development device 13 is reduced.

In the first mode where the lubricant is unlikely to be moved to the development device 13, as described previously, the contact of the photosensitive drum 10 with the developer on the development sleeve 131 is reduced or an electric field in the direction in which the lubricant on the photosensitive drum 10 is moved to the development device 13 is decreased. Specifically, the gap between the development sleeve 131 and the restriction blade 132 is decreased to reduce the amount of lubricant transported; a magnet roller incorporated in the development sleeve 131 is rotated slightly to displace the position of a main pole and a regulation pole, and thus the height of the spearhead of a development brash in a position closest to the photosensitive drum 10 or the amount of transport is reduced; the distance between the photosensitive drum 10 and the development sleeve 131 is increased; and the application of an alternating-current development bias voltage of a development bias voltage where the alternating-current development bias voltage is superimposed on a direct-current development bias voltage is stopped or the rotation of the development sleeve 131 is stopped, and thus the contact of the lubricant applied to the photosensitive drum 10 with the developer is reduced. The absolute value of the direct-current bias voltage Vdc of the development bias voltage is increased, and thus the lubricant is unlikely to be electrically moved to the development device 13. When a non-contact charging device 11 is used as the photosensitive drum 10, a greater influence is produced by the movement of the lubricant to the development device 13.

In order to confirm the effects of the present invention, 150 hundred sheets of character images corresponding to a print coverage rate of 5% were formed per 6 sheets, using “bizhubC8000 (A4 80 horizontal sheets/minute)” made by Konica Minolta, Inc., under development conditions shown in table 1, in an environment of a temperature of 23° C. and a humidity of 65% RH, and the images were evaluated. The amount of lubricant applied was set at about 20 mg per 1000 sheets by adjusting a lubricant pressing pressure. As the lubricant, zinc stearate was used. As the evaluation items of the images, a cleaning failure that is an image noise caused by the wear of the cleaning blade and fogging that is an image noise caused by a decrease in the amount of charge caused by the movement of the lubricant into the development device were used.

In order for the cleaning to be evaluated, immediately after a black solid image was formed in an environment of a temperature of 10° C. and a humidity of 15% RH, a white solid image was formed, and the occurrence of the cleaning failure was visually checked. The case where the cleaning failure occurred is represented by “C”, the case where no cleaning failure occurred is represented by “A” and the case where a minor cleaning failure occurs is represented by “B”.

In order for the fogging to be evaluated, a white solid image was formed in an environment of a temperature of 30° C. and a humidity of 85% RH, and the evaluation of the image was visually performed; the case where the fogging occurred is represented by “C”, the case where no fogging occurred is represented by “A” and the case where minor fogging occurs is represented by “B”. The results are shown on table 1.

The development conditions of examples 1 to 5 were set at normal development conditions at the time of image formation and were set at the development conditions shown on table 1 at the time of no image formation. The development conditions of comparative example 1 were set at normal development conditions both at the time of image formation and at the time of no image formation.

TABLE 1

| | Developer | | | | | | |
|---|---|---|---|---|---|---|---|
| | transport | | Development | | | | |
| | amount | DS distance | sleeve | Development | Fogging margin | | |
| | (g/m²) | (mm) | rotation | bias voltage | ΔV1 (V) | Cleaning | Fogging |
| Example 1 | 300 | 0.25 | Done | DC + AC | 0 | A | B |
| Example 2 | 300 | 0.25 | Done | DC | −150 | A | B |
| Example 3 | 300 | 0.35 | Done | DC + AC | −150 | A | B |
| Example 4 | 150 | 0.25 | Done | DC + AC | −150 | A | A |
| Example 5 | 0 | 0.25 | Done | DC + AC | −150 | A | A |
| Comparative | 300 | 0.25 | Done | DC + AC | −150 | A | C |
| example 1 | | | | | | | |

As is clear from table 1, under the development conditions of examples 1 to 5, satisfactory cleaning was achieved, and though minor fogging occurred under certain conditions, there is no problem in practical use. On the other hand, under the development conditions of comparative example 1, fogging that is problematic in practical use occurred.

Since vibrations are produced when development conditions such as the DS distance, the amount of developer transported and the rotation and stop of the development sleeve are switched, and thus unevenness of pitch may occur, in a full-color image forming device, especially, a tandem-type full-color image forming device, at the time of switching of the development conditions, the development devices of the other colors are preferably in the state of non-image formation. Sufficient time for the switching of the development conditions may be needed. Hence, when there is no sufficient time for the switching of the development conditions, for example, when the development conditions are switched between image formation and image formation in rounds of image formation, the development bias is switched whereas when there is sufficient time, for example, when the development conditions are switched before and after image formation, the development conditions are preferably switched in combination with the switching of the development conditions involving a mechanical operation such as the switching of the amount of developer transported. At the same time, a plurality of development conditions such as the reduction of the development bias and the amount of developer transported are switched in combination, with result that the effects of the present invention are further achieved.

The time when the development conditions are switched to the first mode will now be described. FIG. 3 shows a relationship between the amount of lubricant applied and the friction coefficient μ of the surface of the photosensitive drum when the print coverage rates are 5%, 20% and 100%. The friction coefficient μ of the photosensitive drum 10 is a value that is obtained by performing a measurement after 1000 sheets of images which are 20 mm wide and are formed in the shape of a strip long in the direction of transport of the sheet are individually formed while the print coverage rate is being changed. As is clear from this figure, as the mount of lubricant applied is decreased, the friction coefficient μ of the surface of the photosensitive drum 10 is increased whereas as the mount of lubricant applied is increased, the friction coefficient μ of the surface of the photosensitive drum 10 is decreased. In general, the friction coefficient μ is preferably 0.3 or less. It is also found that as the print coverage rate is increased, the friction coefficient μ is increased. This because as the print coverage rate is increased, the amount of external additive transported to the cleaning device 18 together with the untransferred toner is increased, with result that the layer of the lubricant on the surface of the photosensitive drum 10 is ground.

Hence, when a general image is formed, the lubricant is applied such that friction coefficient μ of the surface of the photosensitive drum 10 is a predetermined position or less whereas when the formation of an image having a high print coverage rate is continued, that is, when the amount of external additive in the cleaning device 18 is increased to increase the grinding force, the amount of lubricant applied is increased, and simultaneously, the development conditions are switched to the first mode in which the lubricant is unlikely to be moved to the development device.

The switching of the amount of lubricant applied and the development conditions is preferably performed, for example, when the drive torque of the photosensitive drum 10 is detected, and the drive torque exceeds a predetermined value or when the total number of pixels in predetermined sheets in each predetermined region exceeds a predetermined value. Specifically, after these conditions hold true, the switching is preferably performed at the time of no image formation before and after image formation or at the time of no image formation when the image formation is interrupted. Here, since it is necessary to switch the amount of lubricant applied and the development conditions for a short period of time, a large amount of lubricant applied is preferably set. Moreover, with consideration given to an error, the amount of lubricant applied is preferably set larger than necessity. The control of the amount of lubricant applied is preferably performed by the rotational speed of the application brush 193, the pressing force of the application brush 193 against the lubricant or the like.

FIG. 4 shows an example of a timing chart for switching the amount of lubricant applied and the development conditions. This example is an example where the image formation is interrupted and the application of the lubricant is performed. The same is true for a case where the amount of lubricant applied and the development conditions are switched before and after the image formation. When the amount of lubricant applied is required to be increased, the image formation is interrupted. Here, the exposure is stopped. Then, the rotational speed of the application brush 193 is increased (for the photosensitive member, a linear speed ratio 0.7→1.5), and thus the amount of lubricant applied is increased. On the other hand, in the development device 13, before a predetermined time when a portion of the surface of the photosensitive drum 10 to which a large amount of lubricant is applied is transported to a position opposite the development device 13, the development conditions are switched to the first mode. Thus, the friction coefficient μ of the surface of the photosensitive drum 10 is decreased, and simultaneously, the movement of the lubricant to the development device 13 is reduced. Thereafter, the rotational speed of the application brush 193 is returned to the original speed. After the portion of the surface of the photosensitive drum 10 to which a large amount of lubricant is applied is passed through the position opposite the development device 13, the development device 13 returns the development conditions to the second mode. After the development conditions of the development device 13 are returned to the second mode, the exposure device 12 returns the development conditions to the normal state.

The results of an actual experiment are shown; the amount of lubricant applied at the time of image formation per 1000 sheets was set at 10 mg, and 1000 sheets of character images having a print coverage rate of 5% and 1000 sheets of images where a black belt 20 mm wide was shown were alternately printed up to 150 thousand sheets. Here, the amount of lubricant applied and the development conditions were switched per 2000 sheets. When amount of lubricant applied was increased with the development conditions kept the same as those at the time of normal image formation, fogging occurred when about 100 thousand sheets were printed. On the other hand, when the development conditions were switched to the first mode (fog margin voltage ΔV1=0), and the amount of lubricant applied was increased, only slight fogging occurred even after 150 hundred sheets were printed. Throughout the printing, the friction coefficient μ of the surface of the photosensitive drum was maintained to be 0.3 or less, with result that there was no problem in the cleaning after the completion of the printing of 150 hundred sheets. Even when the development conditions other than the fog margin voltage ΔV1 were switched to the first mode, only slight fogging likewise occurred, and the cleaning was satisfactorily performed.

Incidentally, when the amount of lubricant applied is increased, and the development conditions are switched to the first mode, a portion grown in a convex shape may be produced in the lubricant layer on the surface of the photosensitive drum 10. On the other hand, when a belt-shaped image is partially present, and a white solid image is continuously formed nearly on the other portions, since the amount of untransferred toner is decreased in a portion corresponding to the white solid portion on the surface of the photosensitive drum, the grinding force to the lubricant layer produced by the cleaning blade 181 with the external additive is reduced. Hence, the portion of the lubricant layer in the convex shape is little cut away by the cleaning blade 181 and is transported to the development device 13, with result that part of the portion of the lubricant layer in the convex shape is likely to be moved to the development device 13 at the time of image formation.

Hence, in order to prevent the problem described above, the portion of the lubricant layer in the convex shape may be scrubbed by the application brush 193. FIG. 5 shows an example of a timing chart.

The timing at which the amount of lubricant applied and the development conditions are switched is the same as that shown in FIG. 4. Vs in FIG. 5 represents the surface potential of the photosensitive drum 10 in a position of contact with the application brush 193, and is controlled by a direct-current voltage component of a bias voltage applied to the static eliminator 17. At the time of normal image formation, in order to reduce memory caused by a positive transfer voltage, a bias voltage whose direct-current voltage component is −1500 V is applied to the static eliminator 17, and thus the surface of the photosensitive drum 10 is charged to about −200 V. In synchronism with the timing at which the development conditions are switched from the first mode to the second mode, the direct-current voltage component applied to the static eliminator 17 is switched from −1500 V to −2.7 kV, and thus the surface of the photosensitive drum 10 is charged to about −600 V.

When in this state, the portion of the lubricant layer in the convex shape reaches the position of contact with the application brush 193, the portion in the convex shape is cut away by being scrubbed through the sliding of the application brush 193, and simultaneously, a negatively charged lubricant is more likely to be electrically moved to the application brush 193. Such a state is performed during at least one revolution of the photosensitive drum 10, and thus most of the portion of the lubricant layer in the convex shape is cut away, with result that the movement of the lubricant to the development device 13 is reduced even when the development conditions are returned to the second mode. In this way, the occurrence of an image noise such as fogging is reduced. When the static eliminator 17 is not included, the bias voltage applied to the application brush 193 is switched, and thus it is possible to obtain the same effects.

In the above embodiment of the present invention, the movement of a lubricant to a development device is reduced while keeping substantially constant the thickness of the lubricant layer on the photosensitive drum 10, with result that the life of the photosensitive drum 10 and the cleaning blade 181 are prolonged and the production of powder smoke in the development device reduces.

What is claimed is:

1. An image forming device comprising:
an image carrying member that is rotatable;
a charging unit that uniformly charges a surface of the image carrying member;
an exposure unit that exposes the image carrying member whose surface is uniformly charged to form an electrostatic latent image;
a development unit that is opposite the image carrying member, that includes a developer carrying member which carries a developer containing a toner and which rotates and transports the developer to a position opposite the image carrying member and that develops, with the developer, the electrostatic latent image formed on the surface of the image carrying member;
a transfer unit that transfers a developed toner image from the image carrying member to a transferred member;
a cleaning unit that is provided on a downstream side in a direction of rotation of the image carrying member with respect to the transfer unit and that makes contact with the surface of the image carrying member to clean the surface of the image carrying member;
a lubricant application unit that applies a lubricant to the surface of the image carrying member; and
a switching control unit that switches a development condition of the development unit between a first mode in which the lubricant applied to the surface of the image carrying member is unlikely to be moved to the development unit and a second mode other than the first mode,
wherein the development condition is set at the first mode at a time of no image formation such that the lubricant is applied to the surface of the image carrying member by the lubricant application unit.

2. The image forming device of claim 1,
wherein in the first mode, an amount of the developer transported by the developer carrying member to the position opposite the image carrying member is reduced than in the second mode.

3. The image forming device of claim 1,
wherein in the first mode, a distance between the developer carrying member and the image carrying member is greater than in the second mode.

4. The image forming device of claim 1,
wherein in the second mode, a voltage obtained by superimposing an alternating-current development bias voltage on a direct-current development bias voltage is applied between the developer carrying member and the image carrying member, and in the first mode, only the direct-current development bias voltage is applied therebetween.

5. The image forming device of claim 1,
wherein before the image formation, after the image formation, between the image formation and the image formation in rounds of the image formation and during interruption of the image formation, the development condition is set at the first mode such that the lubricant is applied to the surface of the image carrying member by the lubricant application unit.

6. The image forming device of claim 1,
wherein at the time of no image formation after a print coverage rate of an image and a number of sheets of images formed are detected and a result of the detection satisfies a predetermined condition, the development condition is set at the first mode such that the lubricant is applied to the surface of the image carrying member by the lubricant application unit.

7. The image forming device of claim 1,
wherein the charging unit does not make contact with the image carrying member.

8. The image forming device of claim 1,
wherein the lubricant application unit is provided on a downstream side in a direction of rotation of the image carrying member with respect to the cleaning member.

9. The image forming device of claim 1,
wherein the lubricant application unit includes a solid lubricant, an application brush that scrubs the lubricant with a brush and applies the lubricant to the image carrying member and a leveling blade that levels the lubricant applied by the application brush in a direction of a shaft of the image carrying member.

10. The image forming device of claim 9,
wherein before the development condition is switched from the first mode to the second mode, during at least one revolution of the image carrying member, a potential difference between the application brush and the image carrying member is set at a potential difference where the lubricant is moved to the application brush more than in the first mode.
